(19) United States
(12) Patent Application Publication
(10) Pub. No.: US 2009/0266241 A1
(43) Pub. Date: Oct. 29, 2009

(54) COOKING UTENSIL USING STEAM

(76) Inventor: Kang-Su Park, Seoul (KR)

Correspondence Address: IPLA P.A., 3580 WILSHIRE BLVD., 17TH FLOOR, LOS ANGELES, CA, 90010, US

(21) Appl. No.: 12/439,331

(22) PCT Filed: Aug. 17, 2007
(86) PCT No.: PCT/KR07/03928

§ 371 Date: Feb. 27, 2009

(30) Foreign Application Priority Data
Aug. 29, 2006 (KR) 10-2006-0082418
Mar. 8, 2007 (KR) 10-2007-0023085

(51) Int. Cl. A47J 27/00; A47J 27/04; F22B 1/28

(52) U.S. Cl. 99/325; 99/447; 99/446; 392/394

(57) ABSTRACT

A cooking utensil using a steam is disclosed, which is characterized in that said steam inlet part and said steam outlet part includes a steam inlet tube and a steam outlet tube connected with a steam supply tube and a steam collection tube of the steam generator, respectively, and an inlet engaging part and an outlet engaging part for engaging the steam collection tube and the steam discharge tube, respectively, and said steam accommodating part includes an inner space for storing a certain amount of the steam, and is made in a flat tube shape having an upper surface and a lower surface.

### TECHNICAL FIELD

The present invention relates to a cooking utensil using steam which is able to cook using steam.

### BACKGROUND ART

Generally, a meat roasting plate placed on a gas range in a restaurant or a kitchen is formed in a double structure consisting of an upper plate for placing meat thereon, and a lower support plate which is engaged to a lower side of the upper plate and has a groove for collecting fat by preventing fat from meat from being dropped toward flame or on a table. With the above structure, meat is roasted.

In a single layer structure roasting plate which is able to collect gat via a hole of one side of the same in a state that fat from meat is collected at a groove formed on an outer surface of a roasting plate, a certain material is coated on an upper plate of the double structure roasting plate, and an upper surface of the single layer structure roasting plate for thereby preventing a sticking of meat and enhancing a taste of meat.

In another roasting plate, a center of a roasting plate is made convex, and cut grooves are formed at regular intervals, and a groove is formed on an outer surface of the same so that soup mixed with meat is boiled, whereby it is possible to roast meat.

However, in the conventional arts, a lower surface of a roasting plate is directly heated using the flame of a gas range for hereby heating meat or the like. When the meat is directly roasted by heat, the meat is stuck on an upper plate and is burnt. So, it is needed to frequently exchange a heated upper plate while cooking meat for thereby causing a lot of inconvenience.

In addition, it is needed to cook after a certain heating time is passed in case that a roasting plate is exchanged with new one, so that a fuel loss increases, and burnt meat may harm health.

### DISCLOSURE OF INVENTION

### Technical Problem

Accordingly, it is an object of the present invention to overcome the problems of the conventional art.

It is another object of the present invention to provide a cooking utensil using steam which is able to cook without sticking or burning by using steam.

It is further another object of the present invention to provide a cooking utensil using steam which is movable since a water tank for storing water, a heater for heating eater, and a cooking part for cooking food using a heat from a steam are integrated in one casing.

### Technical Solution

To achieve the above objects, in a cooking utensil which includes a steam inlet part 100 for receiving steam from a steam generator 1, a steam accommodating part 20 for accommodating steam from the steam inlet part, and a steam outlet part 30 for discharging the steam from the steam accommodating part 20, there is provided a cooking utensil using a steam characterized in that the steam inlet part 10 and the steam outlet part 30 includes a steam inlet tube 11 and a steam outlet tube 31 connected with a steam supply tube 3 and a steam collection tube 5 of the steam generator 1, respectively, and an inlet engaging part 13 and an outlet engaging part 33 for engaging the steam collection tube 5 and the steam outlet tube 31, respectively, and the steam accommodating part 20 includes an inner space 21 for storing a certain amount of the steam, and is made in a flat tube shape having an upper surface 22 and a lower surface 24.

With the above construction, since a direct heat from steam is used for cooking, foods are not stuck on the plate.

In a steam cooking utensil which cooks using heat of steam, there is provided a steam cooking utensil which comprises a water tank 101 for filling water therein; a heater 301 for heating water filled in the water tank 101; a cooking part 501 which cooks foods by receiving steam from the water tank 101 with the help of the heater 301; a pressure adjusting part 701 which adjusts the pressure of the steam from the cooking part 501 for adjusting the temperature of the cooking part 501; and a casing 90 which includes a water tank accommodating space 91 for accommodating the water tank 101, a door 92 for opening and closing the water tank accommodating space 91, and an insertion hole 95 in which the cooking part 501 is inserted and supported, with the pressure adjusting part 701 being supported by the same.

Since a water tank for storing water, a heater for heating eater, and a cooking part for cooking food using a heat from a steam are integrated in one casing, mobility is enhanced, so that it is possible to easily cook at any place where has a certain place for cooking.

In addition, since the above elements are integrated into one casing, the volume of the casing can be minimized, and portability is enhanced.

In a steam cooking utensil which cooks using a heat of steam, there is provided a steam cooking utensil which comprises a food cooking part 500 in which a horizontal surface 510 is formed for placing a food thereon, and an outer surface 520 is integrally formed at an outer side and a lower side of the horizontal surface 510 so that a water accommodating space 530 is formed at a lower side of the horizontal surface 510 for heating the same, and a heater 550 is installed at a lower surface of the water accommodating space 530 so that heat is applied to the water stored in the water accommodating space 530, and a water supply hole 560 is formed at one side of the outer surface 520 for filling water at one side of the same, and an engaging member 590 is formed at an outer side of the outer surface 520; a pressure adjusting part 600 which adjusts a pressure of steam supplied to the cooking part 500 for thereby adjusting the temperature of the cooking part 500; and a cooking casing 900 which includes an insertion hole 950 into which the cooking part 500 is inserted and supported, with the pressure adjusting part 600 being fixedly installed at the same.

So, since water is filled in a cooking part, a water tank is not needed, and a steam tube is not needed. With the above construction, the volume of the casing can be further decreased. A compact size system and lightness can be obtained.

### Advantageous Effects

In the present invention, since cooking is performed using steam, foods are not stuck on the plate and are not burnt.

Since a steam accommodating part uses steam, foods are not stuck or burnt. So, it is possible to use for a long time.

A steam accommodating part is able to endure a high pressure by means of at least one internal force column formed in an interior of a steam accommodating part.

A steam inlet tube and a steam outlet tube engaged at both ends of a steam accommodating part can be easily detachably engaged at a steam generator by means of an inlet engaging part and an outlet engaging part.

A water tank for storing water, a heater for heating eater, and a cooking part for cooking food using a heat from a steam are integrated in one casing.

### BRIEF DESCRIPTION OF THE DRAWINGS

FIG. 1 is a view illustrating a connection state of a steam generator according to the present invention.

FIG. 2 is a perspective view illustrating a steam generator according to a first embodiment of the present invention.

FIG. 3 is a partial perspective view illustrating an inner construction of a steam generator according to the present invention.

FIG. 4 is a perspective view illustrating a steam generator having an internal force column.

FIG. 5 is a perspective view illustrating a steam generator having an outer wall.

FIG. 6 is a perspective view illustrating a steam generator having a fluid discharge part.

FIG. 7 is a perspective view illustrating a steam generator having a fluid discharge part according to a second embodiment.

FIG. 8 is a plane view illustrating a steam generator according to a third embodiment.

FIG. 9 is a plane view illustrating a steam generator according to a fourth embodiment.

FIG. 10 is a partial enlarged view illustrating a steam guide part adapted to a steam generator of FIGS. 8 and 9.

FIG. 11 is a disassembled perspective view of a fifth embodiment of the present invention.

FIG. 12 is a perspective view illustrating an engaging state of FIG. 11.

FIG. 13 is a cross sectional view of FIG. 11.

FIG. 14 is a disassembled perspective view of a sixth embodiment of the present invention.

FIG. 15 is a perspective view of an engaging state of FIG. 14.

FIG. 16 is a cross sectional view of FIG. 14.

FIG. 17 is a disassembled perspective view of a seventh embodiment of the present invention.

FIG. 18 is a perspective view illustrating an engaging state of FIG. 17.

FIG. 19 is a cross sectional view of FIG. 17.

### BEST MODE FOR CARRYING OUT THE INVENTION

In a cooking utensil which includes a steam inlet part 100 for receiving steam from a steam generator 1, a steam accommodating part 20 for accommodating steam from the steam inlet part, and a steam outlet part 30 for discharging the steam from the steam accommodating part 20, there is provided a cooking utensil using a steam characterized in that the steam inlet part 10 and the steam outlet part 30 includes a steam inlet tube 11 and a steam outlet tube 31 connected with a steam supply tube 3 and a steam collection tube 5 of the steam generator 1, respectively, and an inlet engaging part 13 and an outlet engaging part 33 for engaging the steam collection tube 5 and the steam discharge tube 31, respectively, and the steam accommodating part 20 includes an inner space 21 for storing a certain amount of the steam, and is made in a flat tube shape having an upper surface 22 and a lower surface 24.

### MODE FOR THE INVENTION

The embodiments of the present invention will be described with reference to the accommodating drawings.

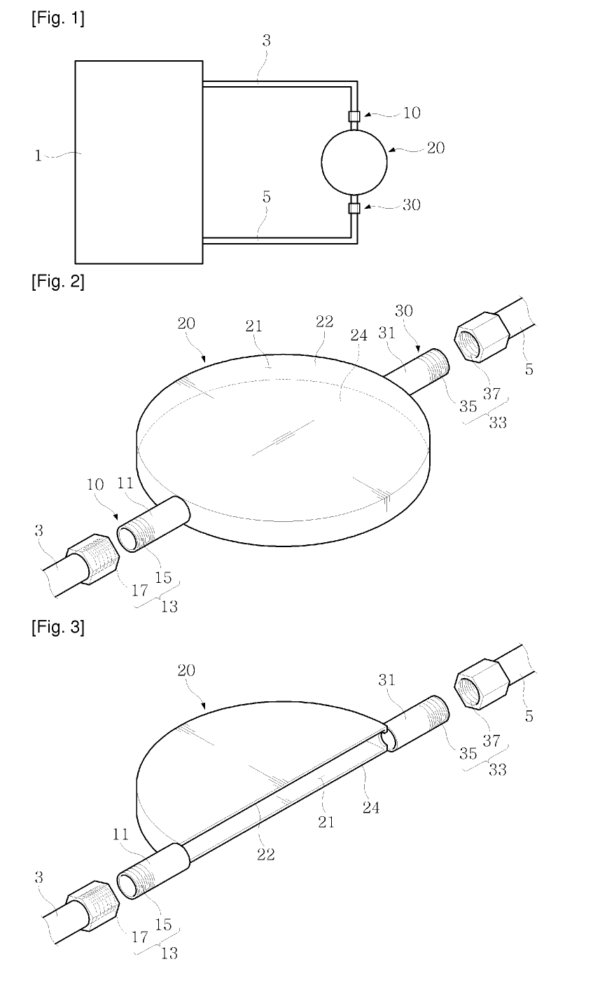

FIG. 1 is a view illustrating a connection state of a steam generator according to the present invention.

As shown in FIG. 1, a cooking utensil of the present invention is connected with a steam generator 1. Here, one or more cooking utensils may be connected with one steam generator 1. The steam generator 1 connected with the cooking utensil of the present invention comprises a steam supply tube 3, and a steam collection tube 5.

FIG. 2 is a perspective view illustrating a steam generator according to a first embodiment of the present invention.

FIG. 3 is a partial perspective view illustrating an inner construction of a steam generator according to the present invention.

As shown in FIGS. 2 and 3, a steam inlet part 10 for receiving steam and a steam outlet part 30 for discharging steam are provided at both ends of the steam accommodating part 20 which stores steam.

The steam inlet part 10 and the steam outlet part 30 are connected with the steam supply tube 3 and the steam collection tube 5, respectively, using a steam inlet tube 11 and a steam outlet tube 31.

The steam inlet tube 11 and the steam outlet tube 31 are connected to the steam supply tube 3 and the steam collection tube 5 by means of an inlet engaging part 13 and an outlet engaging part 33. Namely, an inlet male thread 15 and an outlet male thread 35 are formed on the steam inlet tube 11 and the steam outlet tube 31, and an inlet female thread 17 and an outlet female thread 37 are formed on the steam supply tube 3 and the steam collection tube 5, respectively.

The steam accommodating part 20 is connected with the steam generator 1 for supplying and collecting steam for thereby cooking foods using steam.

An inner space 21 is formed in the steam accommodating part 20 for storing a certain amount of steam. The steam accommodating part 20 is formed in a flat tube shape having an upper surface 22 and a lower surface 24. At this time, the tube shaped steam accommodating part 20 may have a plane shape selected among a circular shape, a triangle shape, a rectangular shape, a pentagonal shape, a hexagonal shape and an octagonal shape.

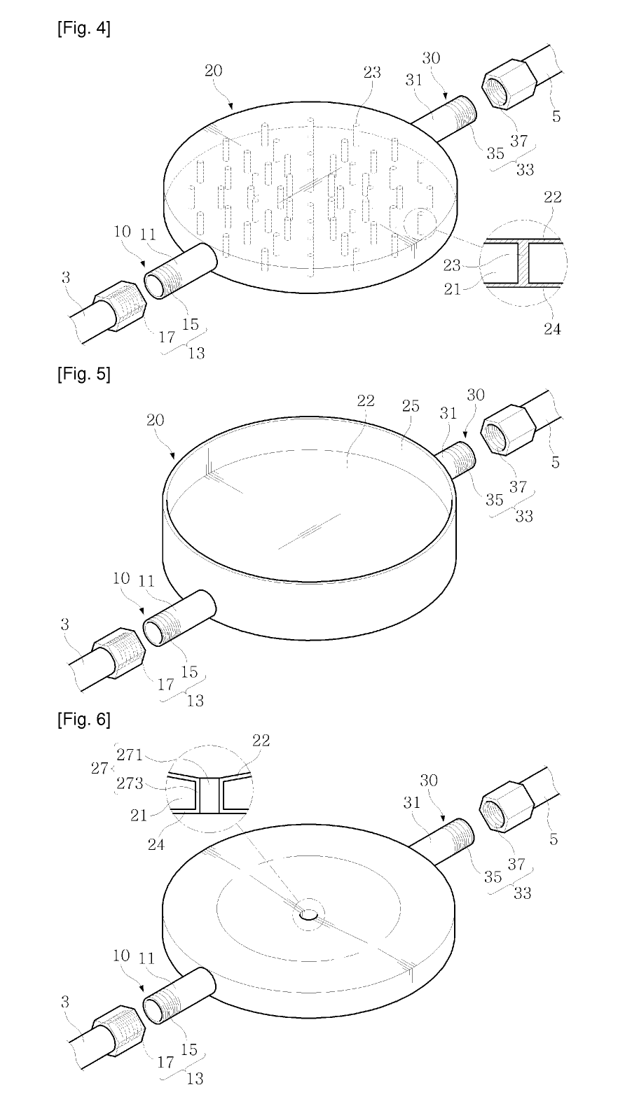

FIG. 4 is a perspective view of a steam generator having an internal force column.

As shown in FIG. 4, the tube shaped steam accommodating part 20 has at least internal force column 23 between the upper surface 22 and the lower surface 22 for enduring the pressure of the steam in the inner space 21.

FIG. 5 is a perspective view illustrating a steam generator having an outer wall.

As shown in FIG. 5, the steam accommodating part 20 further includes an outer wall 25 formed on an outer side of the upper surface 22. Here, the steam accommodating part 20 having the outer wall may be used to cook a certain food having soup like soup, stew, pot stew, etc.

FIG. 6 is a perspective view of a steam generator having a fluid discharge part.

As shown in FIG. 6, the steam accommodating part 20 further includes a fluid discharge part 27 for discharging fluid to the outside which is generated from meat or vegetable when cooking meat, vegetable, etc.

Here, the fluid discharge part 27 has a cylindrical support wall 273 in the inner center portion of the steam accommodating part 20 with a through hole 271 passing through a center of the steam accommodating part 20.

In addition, the upper surface of the steam accommodating part 20 is preferably inclined in the direction of the through hole 271. Namely, the fluid from meat or vegetable is guided and easily collected into the through hole 271 with the help of the inclined upper surface 22.

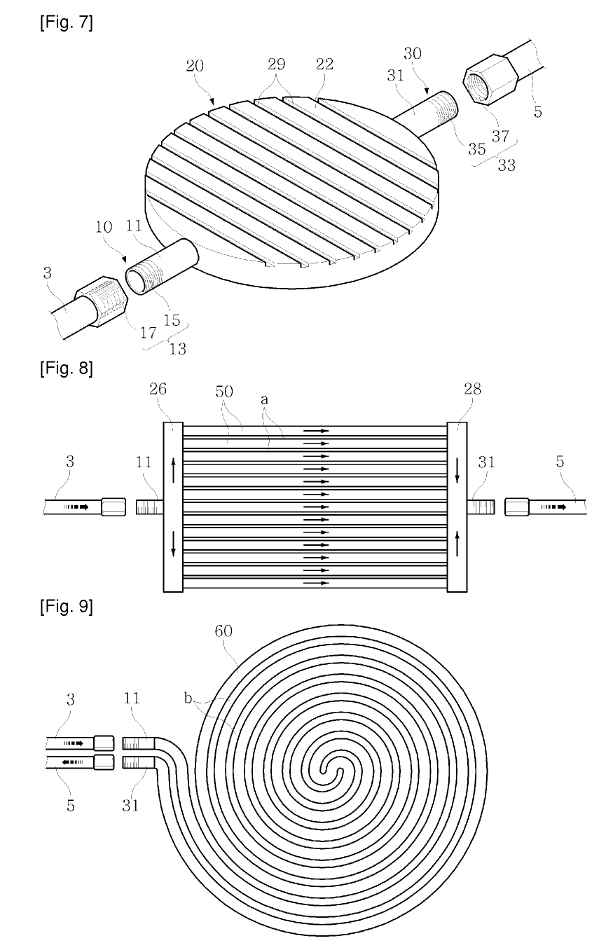

FIG. 7 is a perspective view illustrating a steam generator having a fluid discharge part according to a second embodiment.

As shown in FIG. 7, as another example of the fluid discharge part 27, a plurality of corrugated parts 29 are formed on the upper surface 22. Namely, the fluid from meat or vegetable can be easily discharged to the outside of the steam accommodating part 20 along the corrugated parts 29.

FIG. 8 is a plane view illustrating a steam generator of the third embodiment.

As shown in FIG. 8, as another example of the steam accommodating part 20, a steam distribution supply tube 26 and a steam distribution discharge tube 28 are connected with the steam inlet part 10 and the steam outlet part 30. A plurality of steam accommodating tubes 50 are connected between the steam distribution supply tube 26 and the steam distribution discharge tube 28.

Here, a steam inlet tube 11 and a steam outlet tube 31 are provided at each side of the steam distribution supply tube 26 and the steam distribution discharge tube 28 for a connection with the steam supply tube 3 and the steam collection tube 5.

The diameters of the steam distribution supply tube 26 and the steam distribution discharge tube 28 are larger than that of the steam accommodating tube 50.

A plurality of steam accommodating tubes 50 are installed at regular intervals (a), and the fluid generating during the cooking may be discharged via the intervals (a).

FIG. 9 is a plane view of a steam generator of the fourth embodiment.

As shown in FIG. 9, as further another example of the steam accommodating part 20, a thread shaped tube 60 is connected at both ends of the steam inlet part 10 and the steam outlet part 30. Here, the steam inlet tube 11 and the steam outlet tube 31 are provided at both ends of the thread shaped tube 60 for a connection with the steam supply tube 3 and the steam collection tube 5, respectively.

The thread shaped tubes 60 are installed at regular intervals (b), and the fluid generating during the cooking may be discharged via the intervals (b).

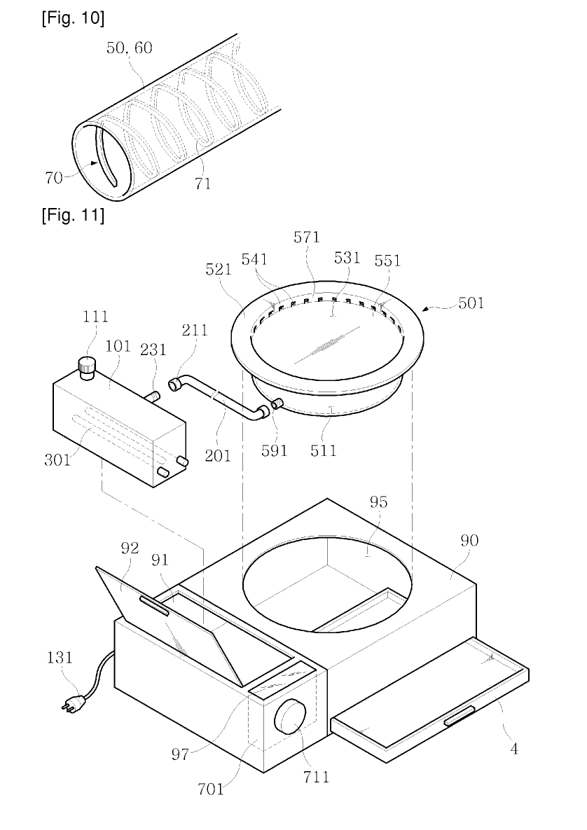

FIG. 10 is a partial enlarged view of a steam guide part adapted to the steam generator of FIGS. 8 and 9.

As shown in FIG. 10, a steam guide part 70 is provided in each interior of the steam accommodating tube 50 and the thread shaped tube 60.

In the steam guide part 70, a thread shaped protrusion 71 is formed on each inner surface of the steam accommodating tube 50 and the thread shaped tube 60.

Since foods are cooked as the steam from the steam generator passes through the cooking utensil using steam of the present invention, the cooking utensil of the present invention, which uses an indirect heat of the steam, can cook for long time.

Other embodiments of the present invention will be described.

FIG. 11 is a disassembled perspective view of the fifth embodiment.

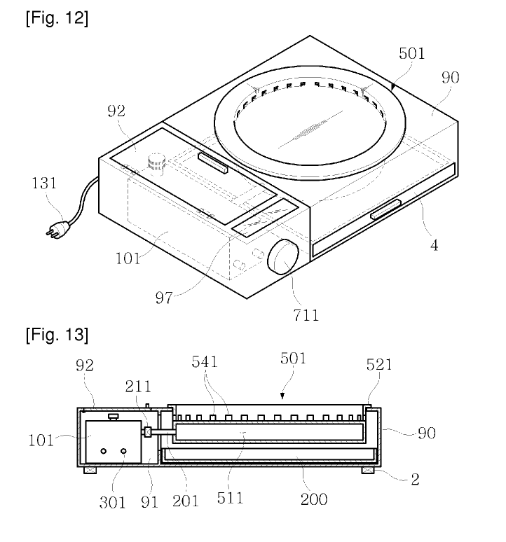

FIG. 12 is a perspective view of an engaging state of FIG. 11.

FIG. 13 is a cross sectional view of FIG. 11.

As shown in FIGS. 11 through 13, in a steam cooking utensil which cooks using heat of steam, there is provided a steam cooking utensil which comprises a water tank 101 for filling water therein; a heater 301 for heating water filled in the water tank 101; a cooking part 501 which cooks foods by receiving steam from the water tank 101 with the help of the heater 301; a pressure adjusting part 701 which adjusts the pressure of the steam from the cooking part 501 for adjusting the temperature of the cooking part 501; and a casing 90 which includes a water tank accommodating space 91 for accommodating the water tank 101, a door 92 for opening and closing the water tank accommodating space 91, and an insertion hole 95 in which the cooking part 501 is inserted and supported, with the pressure adjusting part 701 being supported by the same.

Here, the water tank 101 is preferably made of a transparent or semitransparent material so that the amount of filled water can be visibly checked. Water is stored in the water tank 101 which is opened or closed by a stopper 111. In a state that a door 92 installed at the casing 90 is opened, the water tank 101 is accommodated into the casing 90.

The casing 90 is further provided with a pressure gauge 97 for visibly checking the pressure which is adjusted by a pressure adjusting part. The pressure adjusting part 701 adjusts the pressure using a pressure switch 711.

The heater 301 of the present invention is heated by an electric power supplied via a power cable 131.

The pressure adjusting part 701 is connected via the steam tube 201 so that the steam is supplied from the water tank 101, and the steam used in the cooking part 501 is collected by means of the water tank 101.

The steam tube 201 may be provided by one for supplying and collecting the steam. Two steam tubes may be used in such a manner that steam is supplied to one tube, and the steam is collected via the other tube. A check valve(not shown) is provided for switching the above operation. The steam tube 201 may include a coupler(not shown) for connecting the water tank 101 and the cooking part 501 or a nut 211 is installed at the steam tube 201 in an idle rotation manner, and the thread 231 may be formed at the water tank 101 and the cooking part 501. At this time, the steam tube 201 is preferably made of a flexible material.

The heater 301 is accommodated into the interior of the water tank 101 while contacting with the water of the water tank 101, and is installed on the bottom of the water tank 101.

The cooking part 501 includes a cooking plate 551 which has a steam accommodating space 511 in the interior for accommodating the steam and a horizontal surface 531 formed on the upper side of the same for cooking; an outer wall 571 which has a certain height and is formed on an upper outer side of the cooking plate 551 for preventing cooking food from being escaped to the outside; a steam hole 591 which is formed at one side of the cooking plate 551 for supplying and discharging the steam to the steam accommodating space 511; and an engaging shoulder 521 which is formed on an upper outer side of the outer wall 571 and is supported by the insertion hole 95 of the casing 90.

Here, a plurality of juice discharge holes 541 are formed at the outer wall 571 at regular intervals for thereby discharging the juice from foods to the lower side of the cooking part 501. A steam tube 201 is connected with the steam hole 591.

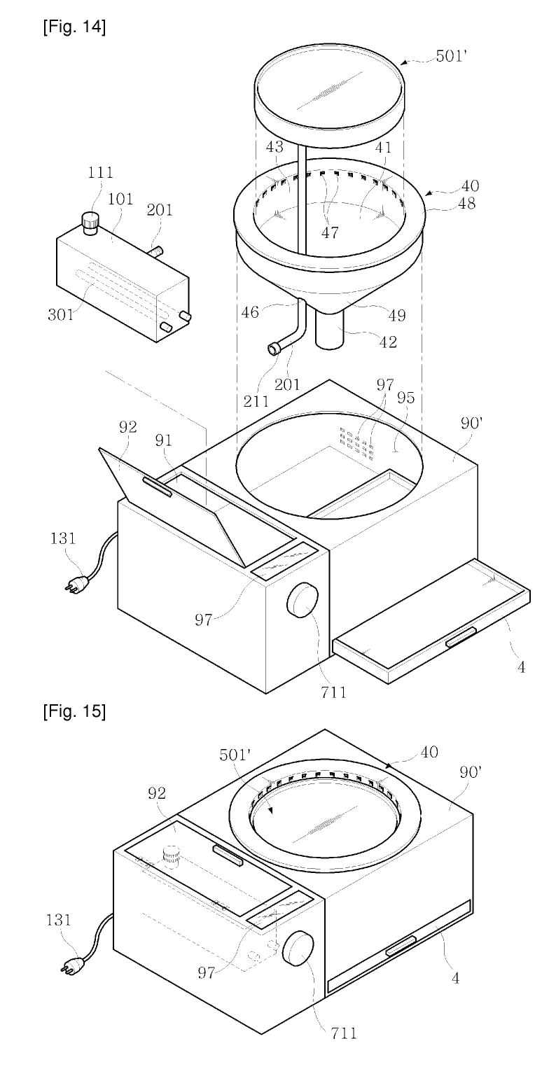

FIG. 14 is a disassembled perspective view of the sixth embodiment of the present invention.

FIG. 15 is a perspective view of an engaging state of FIG. 14.

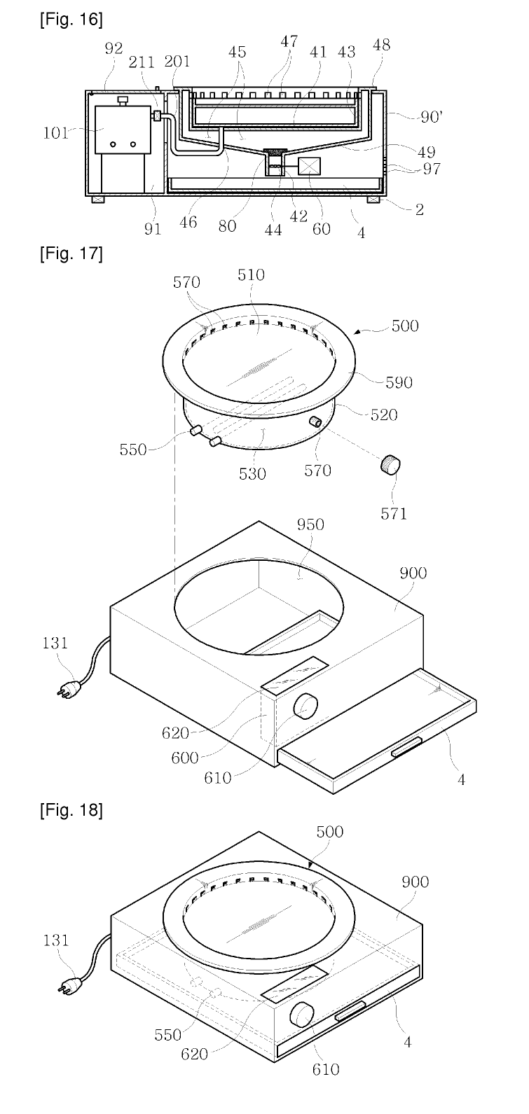

FIG. 16 is a cross sectional view of FIG. 14.

As shown in FIGS. 14 through 16, the casing 90′ is supported by an insertion hole of the casing 90′. There is further provided a discharge guide 40 for discharging the juice from the food and food smell from the cooking part 501′.

The discharge guide 40 includes an accommodating surface 41 which supports a lower surface of the cooking part 501 so that the cooking part 501 is accommodated; an accommodating wall 43 which is formed higher than the height of the cooking part 501 at an outer side of the accommodating surface 41 and supports an outer surface of the cooking part 501; a discharge space 45 which is formed in the interiors of the accommodating surface 41 and the accommodating wall 43; a plurality of discharge holes 47 which are formed on an upper side of the accommodating wall 43 and communicates with the discharge space so that the food juice and smell being cooked on the cooking part 501 are discharged to the outside via the discharge space 45; a conical shaped inclined surface 49 which is formed at a lower side of the discharge space 45 for collecting and discharging food juice inputted via the discharge hole 47; a discharge tube 42 which is formed at a center of the conical shaped inclined surface 49; a fan 44 which is installed at the discharge tube 42 for forcibly discharging the food smell; a through hole 271 which passes through the conical shaped inclined surface from the accommodating surface 41 so that the steam tube 201 connected with the cooking part 501 passes through; and a guide shoulder 48 which is formed at an upper outer side of the accommodating surface 41 for thereby being supported by the insertion hole 95 of the casing 90.

Here, the discharge tube 42 passes from the casing 90′ to the outside for thereby discharging food smell to the outside. It may be installed near the discharge tube 42 near an outer wall of the casing 90′, and the casing discharge hole 97 may be formed at the casing 90′ near the discharge tube 42. In addition, the discharge tube 42 is preferably made of a flexible material. The fan 44 rotates by means of the motor M and discharges food smell to the outside.

The cooking part 501′ has the same height as the discharge hole 47.

The discharge guide 40 further includes a filter 80 which is installed at a discharge tube 42 for purifying food smell.

The filter 80 is made of a pad containing non-woven cloths or charcoal for thereby removing food smell.

In addition, the casing 90′ has a certain height which is determined based on the entire height of the discharge guide 40.

FIG. 17 is a disassembled perspective view of a seventh embodiment of the present invention.

FIG. 18 is a perspective view of an engaging state of FIG. 17.

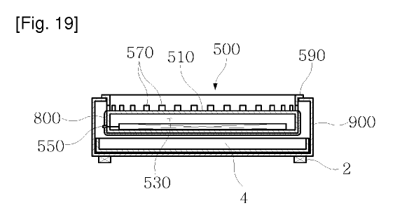

FIG. 19 is a cross sectional view of FIG. 17.

As shown in FIGS. 17 through 19, in a steam cooking utensil which cooks using a heat of steam, there is provided a steam cooking utensil which comprises a food cooking part 500 in which a horizontal surface 510 is formed for placing a food thereon, and an outer surface 520 is integrally formed at an outer side and a lower side of the horizontal surface 510 so that a water accommodating space 530 is formed at a lower side of the horizontal surface 510 for heating the same, and a heater 550 is installed at a lower surface of the water accommodating space 530 so that heat is applied to the water stored in the water accommodating space 530, and a water supply hole 560 is formed at one side of the outer surface 520 for filling water at one side of the same, and an engaging member 590 is formed at an outer side of the outer surface 520; a pressure adjusting part 600 which adjusts a pressure of steam supplied to the cooking part 500 for thereby adjusting the temperature of the cooking part 500; and a cooking casing 900 which includes an insertion hole 950 into which the cooking part 500 is inserted and supported, with the pressure adjusting part 600 being fixedly installed at the same.

Here, the water supply hole 560 is opened and closed by means of the stopper 561. The water supply hole 560 and the stopper 561 are preferably engaged by means of threads.

The water supply hole 560 of the food cooking part 500 is preferably formed at an intermediate height of the food cooking part 500 so that water is filled in the water accommodating space 530 of the food cooking part 500 by half. Here, when water is filled by 50% or below 50%, steam may generate from the remaining spaces.

The pressure adjusting part 600 has a pressure adjusting switch 610, and a pressure gauge 620.

As shown in FIGS. 11 through 19, the casing 90 and the cooking casing 900 further include a juice container 4 for collecting and storing the juice from the cooking part 501 and the food cooking part 500.

The juice container 4 preferable has a width wider than that of the cooking part so that juice or other foreign substances from the cooking part 501 and the food cooking part 500 are easily collected. In addition, the juice container 4 detachably slides in the interior of the casing 90 and the cooking casing 900 like a drawer.

The casing 90 and the cooking casing 900 further include a sensor 2 which is able to detect when the casing 90 and the cooking casing 900 drop down and disconnect the power supply for thereby preventing a certain fire.

The cooking part 501 and the food cooking part 500 further include an adiabatic material 800 attached to the portions except to the upper side (refer to FIG. 19).

Here, the adiabatic material 800 is preferably made of a ceramic fiber adiabatic material or a porous foam plastic and urethane for effectively disconnecting heat. A ceramic or urethane may be coated on an outer surface of the cooking part 501 and the food cooking part 500 for preventing heat from the cooking part 501 and the food cooking part 500 from being discharged to the portion except to the upper side.

In addition, in the present invention, a heat accumulation material, which is one of heat transfer mediums, may be used instead of using a heat from steam. Namely, a heat accumulation material is filled in the water tank and the food cooking part, and it is heated by means of the heater for thereby cooking foods. Here, a heat accumulation material is alkyl benzene.

When cooking foods, the foods are cooked using a heat from steam, not directly using the heat, the foods are not burnt and cooked, so that it is very good for health.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

In the present invention, since cooking is performed using steam, foods are not stuck on the plate and are not burnt.

Since a steam accommodating part uses steam, foods are not stuck or burnt. So, it is possible to use for a long time.

A steam accommodating part is able to endure a high pressure by means of at least one internal force column formed in an interior of a steam accommodating part.

A steam inlet tube and a steam outlet tube engaged at both ends of a steam accommodating part can be easily detachably engaged at a steam generator by means of an inlet engaging part and an outlet engaging part.

A water tank for storing water, a heater for heating eater, and a cooking part for cooking food using a heat from a steam are integrated in one casing.

1. In a cooking utensil which includes a steam inlet part (100) for receiving steam from a steam generator (1), a steam accommodating part (20) for accommodating steam from the steam inlet part, and a steam outlet part (30) for discharging the steam from the steam accommodating part (20), a cooking utensil using a steam characterized in that:
said steam inlet part (10) and said steam outlet part (30) includes a steam inlet tube (11) and a steam outlet tube (31) connected with a steam supply tube (3) and a steam collection tube (5) of the steam generator (1), respectively, and an inlet engaging part (13) and an outlet engaging part (33) for engaging the steam collection tube (5) and the steam discharge tube (31), respectively, and said steam accommodating part (20) includes an inner space (21) for storing a certain amount of the steam, and is made in a flat tube shape having an upper surface (22) and a lower surface (24).

2. The utensil of claim 1, wherein said steam accommodating part (20) of the tube shape includes at least one internal force column (23) between the upper surface (22) and the lower surface (24) for enduring a pressure of the steam in the inner space (21).

3. The utensil of claim 1, wherein said steam accommodating part (20) includes an outer wall formed at an outer side of the upper surface (22).

4. The utensil of claim 1, wherein said steam accommodating part (20) includes a fluid discharge part (27) for discharging fluid from the foods being cooked on the upper side of the same to the outside.

5. The utensil of claim 4, wherein said fluid discharge part (27) includes a cylindrical support wall at a center inner side of the steam accommodating part (20) so that a through hole (271) is formed at a center of the steam accommodating part (20).

6. The utensil of claim 4, wherein said fluid discharge part (27) includes a plurality of corrugated parts (29) on the upper surface (22).

7. The utensil of claim 1, wherein said steam accommodating part (20) includes:
a steam distribution supply tube (26) and a steam distribution discharge tube (28) connected with the steam inlet part (10) and the steam outlet part (20), respectively; and
a plurality of steam accommodating tubes (50) connected between the steam distribution supply tube (26) and the steam distribution discharge tube (28), respectively.

8. The utensil of claim 1, wherein said steam accommodating part (20) is formed in a thread shape tube (60) of which both ends are connected with the steam inlet part (10) and the steam outlet part (30), respectively.

9. The utensil of claim 7, wherein said steam accommodating tube (50) and said thread shaped tube (60) further include a steam guide part (70) in their interiors, respectively.

10. In a steam cooking utensil which cooks using heat of steam, a steam cooking utensil, comprising:
a water tank (101) for filling water therein;
a heater (301) for heating water filled in the water tank (101);
a cooking part (501) which cooks foods by receiving steam from the water tank (101) with the help of the heater (301);
a pressure adjusting part (701) which adjusts the pressure of the steam from the cooking part (501) for adjusting the temperature of the cooking part (501); and
a casing (90) which includes a water tank accommodating space (91) for accommodating the water tank (101), a door (92) for opening and closing the water tank accommodating space (91), and an insertion hole (95) in which the cooking part (501) is inserted and supported, with the pressure adjusting part (701) being supported by the same.

11. The utensil of claim 10, wherein said water tank (101) and said cooking part (501) are connected via a steam tube (201) for supplying steam supplied from the water tank (101), and for collecting the steam used in the cooking part (501) to the water tank (101).

12. The utensil of claim 10, wherein said heater (301) is accommodated in the interior of the water tank (101) while contacting with the water of the water tank (101), and is installed on a bottom of the water tank.

13. The utensil of claim 10, wherein said cooking part (501) includes:
a cooking plate (551) which has a steam accommodating space (511) in the interior for accommodating the steam and a horizontal surface (531) formed on the upper side of the same for cooking;
an outer wall (571) which has a certain height and is formed on an upper outer side of the cooking plate (551) for preventing cooking food from being escaped to the outside;
a steam hole (591) which is formed at one side of the cooking plate (551) for supplying and discharging the steam to the steam accommodating space (511); and
an engaging shoulder (521) which is formed on an upper outer side of the outer wall (571) and is supported by the insertion hole (95) of the casing (90).

14. The utensil of claim 10, wherein said casing (90) further includes a discharge guide (40) which is supported by the insertion hole (95) of the casing (90) and discharges food juice and smell from the cooking part (501) to the outside, with the cooking part (501) being accommodated by means of the same.

15. The utensil of claim 14, wherein said discharge guide (40) includes:
an accommodating surface (41) which supports a lower surface of the cooking part (501) so that the cooking part (501) is accommodated;
an accommodating wall (43) which is formed higher than the height of the cooking part (501) at an outer side of the accommodating surface (41) and supports an outer surface of the cooking part (501);
a discharge space (45) which is formed in the interiors of the accommodating surface (41) and the accommodating wall (43);
a plurality of discharge holes (47) which are formed on an upper side of the accommodating wall (43) and communicates with the discharge space so that the food juice and smell being cooked on the cooking part (501) are discharged to the outside via the discharge space (45);
a conical shaped inclined surface (49) which is formed at a lower side of the discharge space (45) for collecting and discharging food juice inputted via the discharge hole (47);
a discharge tube (42) which is formed at a center of the conical shaped inclined surface (49);
a fan (44) which is installed at the discharge tube (42) for forcibly discharging the food smell;
a through hole (271) which passes through the conical shaped inclined surface from the accommodating surface (41) so that the steam tube (201) connected with the cooking part (501) passes through; and
a guide shoulder (48) which is formed at an upper outer side of the accommodating surface (41) for thereby being supported by the insertion hole (95) of the casing (90).

16. The utensil of claim 15, wherein said discharge guide (40) further includes a filter (80) installed at the discharge tube (42) for purifying food smell.

17. In a steam cooking utensil which cooks using a heat of steam, a steam cooking utensil, comprising:
a food cooking part (500) in which a horizontal surface (510) is formed for placing a food thereon, and an outer surface (520) is integrally formed at an outer side and a lower side of the horizontal surface (510) so that a water accommodating space (530) is formed at a lower side of the horizontal surface (510) for heating the same, and a heater (550) is installed at a lower surface of the water accommodating space (530) so that heat is applied to the water stored in the water accommodating space (530), and a water supply hole (560) is formed at one side of the outer surface (520) for filling water at one side of the same, and an engaging member (590) is formed at an outer side of the outer surface (520);
a pressure adjusting part (600) which adjusts a pressure of steam supplied to the cooking part (500) for thereby adjusting the temperature of the cooking part (500); and
a cooking casing (900) which includes an insertion hole (950) into which the cooking part (500) is inserted and supported, with the pressure adjusting part (600) being fixedly installed at the same.

18. The utensil of claim 17, wherein said water supply hole (560) of the food cooking part (500) is formed at an intermediate height of the food cooking part so that water is filled in the water accommodating space of the food cooking part by about 50%.

19. The utensil of claim 10, wherein said casing (90) and said cooking casing (900) further include a juice container (4) for collecting and storing the juice from the cooking part (500).

20. The utensil of claim 10, wherein said casing (90) and said cooking casing (900) further include a sensor (2) for detecting when the casing (90) and the cooking casing (900) drop down and disconnecting a power supply for thereby preventing a certain fire.

21. The utensil of claim 10, wherein said cooking part (501) and said food cooking part (500) further include an adiabatic material (800) which is attached to a portion except to an upper side of the same.

22. The utensil of claim 17, wherein said casing (90) and said cooking casing (900) further include a juice container (4) for collecting and storing the juice from the cooking part (500).

23. The utensil of claim 17, wherein said casing (90) and said cooking casing (900) further include a sensor (2) for detecting when the casing (90) and the cooking casing (900) drop down and disconnecting a power supply for thereby preventing a certain fire.

24. The utensil of claim 17, wherein said cooking part (501) and said food cooking part (500) further include an adiabatic material (800) which is attached to a portion except to an upper side of the same.
